(19) United States
(12) Patent Application Publication
(10) Pub. No.: US 2025/0232469 A1
(43) Pub. Date: Jul. 17, 2025

(54) SELF-SUPERVISED INCREMENTAL TRAINING OF A RELOCALIZER MODEL

(71) Applicant: Niantic, Inc., San Francisco, CA (US)

(72) Inventors: Eric Brachmann, Hanover (DE); Jamie Michael Wynn, London (GB); Tommaso Cavallari, Oxford (GB); Aron Monszpart, London (GB); Daniyar Turmukhambetov, London (GB); Victor Adrian Prisacariu, Oxford (GB)

(21) Appl. No.: 19/024,942

(22) Filed: Jan. 16, 2025

Related U.S. Application Data
(60) Provisional application No. 63/622,031, filed on Jan. 17, 2024.

(51) Int. Cl. G06T 7/73; G06T 19/00

(52) U.S. Cl. CPC G06T 7/73; G06T 19/006; G06T 2207/20081; G06T 2207/20084

(57) ABSTRACT

A relocalizer model for an environment is trained using an iterative process. To initialize the relocalizer model, an initial image is registered with its camera pose established as the reference. In each subsequent iteration of training, the relocalizer model is applied to additional images to predict pose estimates for the images. The images and their pose estimates are then leveraged in retraining of the relocalizer model. In general, the training of the relocalizer model entails extracting scene coordinates for pixels of a training image. The scene coordinates are then projected into a projection based on the pose estimate of the training image. A loss is calculated between the projection and the training image. And parameters of the relocalizer model are adjusted to minimize the loss. The iterative training may continue until an end condition is met. The trained relocalizer model is configured to input an image of the environment and to output the camera pose for the image.

### CROSS-REFERENCE TO RELATED APPLICATIONS

The present application claims the benefit of and priority to U.S. Provisional Application No. 63/622,031 filed on Jan. 17, 2024, which is incorporated by reference in its entirety.

### BACKGROUND

### 1. Technical Field

The subject matter described relates generally to scene coordinate reconstruction, and, in particular, to using an iterative process of registering views and training a relocalizer model.

### 2. Problem

Structure-from-motion refers to a process for determining the location and orientation (pose) of a camera within an environment using a set of images of the environment. Popular existing approaches for structure-from-motion start from an initialization and repeat triangulation of sparse 3D points, refinement of the reconstruction, and registration of more camera views by estimating their poses. This process is accurate but slow, involving local feature matching between large numbers of pairs of images. For example, COLMAP (the gold standard of existing structure-by-motion tools) can take days to reconstruct scenes with thousands of views. There is therefore a need for more rapid scene coordinate reconstruction methods that have comparable accuracy to COLMAP.

### SUMMARY

The present disclosure describes an alternative to existing structure-by-motion approaches that uses self-supervised incremental learning of a visual relocalizer model. The training approach alternates between neural mapping, that is scene reconstruction with posed image data, and relocalization of additional image data to estimate poses for the image data. This oscillatory approach sidesteps the need for ground truth pose data, as the relocalizer model leverages self-supervision from estimated poses. As the relocalizer model is incrementally trained, the training process avoids getting bogged down in feature matching across the entire training data set. The approach may estimate the camera poses of thousands of images an order of magnitude faster than COLMAP and to a comparable accuracy.

### BRIEF DESCRIPTION OF THE DRAWINGS

FIG. 1 illustrates a networked computing environment, in accordance with one or more embodiments.

FIG. 2 depicts a representation of a virtual world having a geography that parallels the real world, in accordance with one or more embodiments.

FIG. 3 depicts an exemplary game interface of a parallel reality game, in accordance with one or more embodiments.

FIG. 4 is a conceptual diagram that depicts the training process of a relocalizer model, in accordance with one or more embodiments.

FIG. 5 is a flowchart of a method for training the scene-specific regression head network, in accordance with one or more embodiments.

FIG. 6 is a conceptual diagram of self-supervised incremental training of a relocalizer model, in accordance with one or more embodiments.

FIG. 7 is a flowchart that describes self-supervised incremental training of a relocalizer model, in accordance with one or more embodiments.

FIG. 8 is a flowchart that describes the generation of camera poses, according to one or more embodiments.

FIG. 9 illustrates an example computer system suitable for use in training or applying a depth estimation model, according to one or more embodiments.

The figures and the following description describe certain embodiments by way of illustration only. One skilled in the art will readily recognize from the following description that alternative embodiments of the structures and methods may be employed without departing from the principles described. Reference will now be made to several embodiments, examples of which are illustrated in the accompanying figures.

### DETAILED DESCRIPTION

### Exemplary Location-Based Parallel Reality Gaming System

Various embodiments are described in the context of a parallel reality game that includes augmented reality content in a virtual world geography that parallels at least a portion of the real-world geography such that player movement and actions in the real-world affect actions in the virtual world and vice versa. Those of ordinary skill in the art, using the disclosures provided herein, will understand that the subject matter described is applicable in other situations where determining depth information from image data is desirable. In addition, the inherent flexibility of computer-based systems allows for a great variety of possible configurations, combinations, and divisions of tasks and functionality between and among the components of the system. For instance, the systems and methods according to aspects of the present disclosure can be implemented using a single computing device or across multiple computing devices (e.g., connected in a computer network).

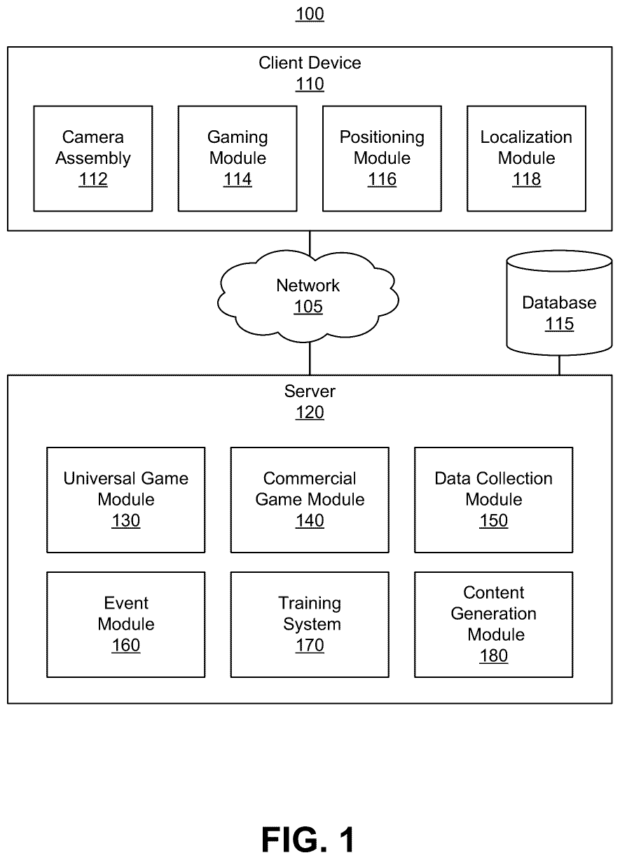

FIG. 1 illustrates a networked computing environment 100, in accordance with one or more embodiments. The networked computing environment 100 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 110 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 110.

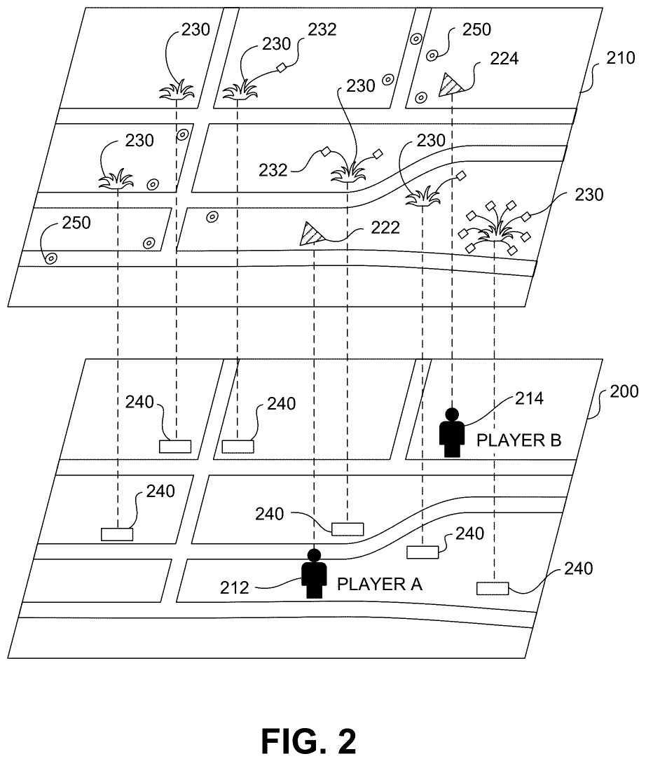

Reference is now made to FIG. 2 which depicts a conceptual diagram of a virtual world 210 that parallels the real world 200 that can act as the game board for players of a parallel reality game, according to one embodiment. As illustrated, the virtual world 210 can include a geography that parallels the geography of the real world 200. In particular, a range of coordinates defining a geographic area or space in the real world 200 is mapped to a corresponding range of coordinates defining a virtual space in the virtual world 210. The range of coordinates in the real world 200 can be associated with a town, neighborhood, city, campus, locale, a country, continent, the entire globe, or other geographic area. Each geographic coordinate in the range of geographic coordinates is mapped to a corresponding coordinate in a virtual space in the virtual world.

A player's position in the virtual world 210 corresponds to the player's position in the real world 200. For instance, the player A located at position 212 in the real world 200 has a corresponding position 222 in the virtual world 210. Similarly, the player B located at position 214 in the real world has a corresponding position 224 in the virtual world. As the players move about in a range of geographic coordinates in the real world, the players also move about in the range of coordinates defining the virtual space in the virtual world 210. In particular, a positioning system (e.g., a GPS system) associated with a mobile computing device carried by the player can be used to track a player's position as the player navigates the range of geographic coordinates in the real world. Data associated with the player's position in the real world 200 is used to update the player's position in the corresponding range of coordinates defining the virtual space in the virtual world 210. In this manner, players can navigate along a continuous track in the range of coordinates defining the virtual space in the virtual world 210 by simply traveling among the corresponding range of geographic coordinates in the real world 200 without having to check in or periodically update location information at specific discrete locations in the real world 200.

The location-based game can include a plurality of game objectives requiring players to travel to and/or interact with various virtual elements and/or virtual objects scattered at various virtual locations in the virtual world. A player can travel to these virtual locations by traveling to the corresponding location of the virtual elements or objects in the real world. For instance, a positioning system can continuously track the position of the player such that as the player continuously navigates the real world, the player also continuously navigates the parallel virtual world. The player can then interact with various virtual elements and/or objects at the specific location to achieve or perform one or more game objectives.

For example, a game objective has players interacting with virtual elements 230 located at various virtual locations in the virtual world 210. These virtual elements 230 can be linked to landmarks, geographic locations, or objects 240 in the real world 200. The real-world landmarks or objects 240 can be works of art, monuments, buildings, businesses, libraries, museums, or other suitable real-world landmarks or objects. Interactions include capturing, claiming ownership of, using some virtual item, spending some virtual currency, etc. To capture these virtual elements 230, a player must travel to the landmark or geographic location 240 linked to the virtual elements 230 in the real world and must perform any necessary interactions with the virtual elements 230 in the virtual world 210. For example, player A of FIG. 2 may have to travel to a landmark 240 in the real world 200 in order to interact with or capture a virtual element 230 linked with that particular landmark 240. The interaction with the virtual element 230 can require action in the real world, such as taking a photograph and/or verifHing, obtaining, or capturing other information about the landmark or object 240 associated with the virtual element 230.

Game objectives may require that players use one or more virtual items that are collected by the players in the location-based game. For instance, the players may travel the virtual world 210 seeking virtual items (e.g., weapons, creatures, power ups, or other items) that can be useful for completing game objectives. These virtual items can be found or collected by traveling to different locations in the real world 200 or by completing various actions in either the virtual world 210 or the real world 200. In the example shown in FIG. 2, a player uses virtual items 232 to capture one or more virtual elements 230. In particular, a player can deploy virtual items 232 at locations in the virtual world 210 proximate or within the virtual elements 230. Deploying one or more virtual items 232 in this manner can result in the capture of the virtual element 230 for the particular player or for the team/faction of the particular player.

In one particular implementation, a player may have to gather virtual energy as part of the parallel reality game. As depicted in FIG. 2, virtual energy 250 can be scattered at different locations in the virtual world 210. A player can collect the virtual energy 250 by traveling to the corresponding location of the virtual energy 250 in the actual world 200. The virtual energy 250 can be used to power virtual items and/or to perform various game objectives in the game. A player that loses all virtual energy 250 can be disconnected from the game.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. In some embodiments, players can communicate with one another through one or more communication interfaces provided in the game. Players can also obtain enhanced “powers” or virtual items that can be used to complete game objectives within the game. Those of ordinary skill in the art, using the disclosures provided herein, should understand that various other game features can be included with the parallel reality game without deviating from the scope of the present disclosure.

Referring back FIG. 1, the networked computing environment 100 uses a client-server architecture, where a server 120 communicates with a client device 110 over a network 105, e.g., to provide a parallel reality game to players at the client device 110. The networked computing environment 100 may provide other computer functionality, e.g., generating virtual content in part by the server 120 for distribution to the client device 110, or generating navigational instructions by the server 120 for controlling operation of a client device 110 embodied as an autonomous agent. The networked computing environment 100 also may include other external systems such as other content creation systems or business systems. Although only one client device 110 is illustrated in FIG. 1, any number of clients 110 or other external systems may be connected to the server 120 over the network 105. Furthermore, the networked computing environment 100 may contain different or additional elements and functionality may be distributed between the client device 110 and the server 120 in a different manner than described below.

A client device 110 can be any portable computing device that can be used by a player to interface with the server 120. For instance, a client device 110 can be a wireless device, a personal digital assistant (PDA), portable gaming device, cellular phone, smart phone, tablet, navigation system, handheld GPS system, wearable computing device, a display having one or more processors, or other such device. In another instance, the client device 110 includes a conventional computer system, such as a desktop or a laptop computer. Still yet, the client device 110 may be a vehicle with a computing device. In short, a client device 110 can be any computer device or system that can enable a player to interact with the server 120. As a computing device, the client device 110 can include one or more processors and one or more computer-readable storage media. The computer-readable storage media can store instructions which cause the processor to perform operations. The client device 110 is preferably a portable computing device that can be easily carried or otherwise transported with a player, such as a smartphone or tablet.

In an embodiment, the client device executes an application allowing the user of the client device 110 to interact with the server 120 or other components of the system environment 100. For example, a client device 110 can execute an application associated with the parallel reality game to enable interaction between the client device 110 and the server 120 or other components of the system environment 100 via the network 105. In another embodiment, the client device 110 interacts with the server 120 or other components of the system environment 100 through an application programming interface (API) running on a native operating system of the client device 110, such as IOS® or ANDROID™.

In one or more embodiments, the client device 110 communicates with the server 120, providing the server 120 with sensory data of a physical environment. The client device 110 includes a camera assembly 112 that captures image data in two dimensions of a scene in the physical environment where the client device 110 is. In the embodiment shown in FIG. 1, each client device 110 includes software components such as a gaming module 114 and a positioning module 116. In an embodiment, the client device 110 further includes a localization module 118. The client device 110 may include various other input/output devices for receiving information from and/or providing information to a player. Example input/output devices include a display screen, a touch screen, a touch pad, data entry keys, speakers, and a microphone suitable for voice recognition. The client device 110 may also include additional sensors for recording data from the environment of the client device 110, the sensors including but not limited to, movement sensors, accelerometers, gyroscopes, other inertial measurement units (IMUs), barometers, positioning systems, thermometers, light sensors, microphones, etc.

The client device 110 can further include a network interface (not shown) for providing communications over the network 105. A network interface can include any suitable components for interfacing with one more networks, including for example, transmitters, receivers, ports, controllers, antennas, or other suitable components.

The camera assembly 112 captures image data of a scene of the environment where the client device 110 is in. The camera assembly 112 may utilize a variety of varying photo sensors with varying color capture ranges at varying capture rates. The camera assembly 112 may contain a wide-angle lens or a telephoto lens. The camera assembly 112 may be configured to capture single images or video as the image data. Additionally, the orientation of the camera assembly 112 could be parallel to the ground with the camera assembly 112 aimed at the horizon. The camera assembly 112 captures image data and shares the image data with the computing device on the client device 110. The image data can be appended with metadata describing other details of the image data including sensory data (e.g., temperature, brightness of environment) or capture data (e.g., exposure, warmth, shutter speed, focal length, capture time, etc.). The camera assembly 112 can include one or more cameras which can capture image data. In one instance, the camera assembly 112 comprises one camera and is configured to capture monocular image data. In another instance, the camera assembly 112 comprises two cameras and is configured to capture stereoscopic image data. In various other implementations, the camera assembly 112 comprises a plurality of cameras each configured to capture image data. Each camera of the camera assembly 126 may append each image with metadata, e.g., including camera parameters such as lens focal length, shutter speed, exposure values, etc.

The gaming module 114 provides a player with an interface to participate in the parallel reality game. The server 120 transmits game data over the network 105 to the client device 110 for use by the gaming module 114 at the client device 110 to provide local versions of the game to players at locations remote from the server 120. The server 120 can include a network interface for providing communications over the network 105. A network interface can include any suitable components for interfacing with one more networks, including for example, transmitters, receivers, ports, controllers, antennas, or other suitable components.

The gaming module 114 executed by the client device 110 provides an interface between a player and the parallel reality game. The gaming module 114 can present a user interface on a display device associated with the client device 110 that displays a virtual world (e.g., renders imagery of the virtual world) associated with the game and allows a user to interact in the virtual world to perform various game objectives. In some other embodiments, the gaming module 114 presents image data from the real world (e.g., captured by the camera assembly 112) augmented with virtual elements from the parallel reality game. In these embodiments, the gaming module 114 may generate virtual content and/or adjust virtual content according to other information received from other components of the client device 110. For example, the gaming module 114 may adjust a virtual object to be displayed on the user interface according to a depth map of the scene captured in the image data.

In one or more embodiments, the gaming module 114 may present a digitized spatial representation of a real-world scene. In such embodiments, the spatial representation may be previously generated from image data comprising a plurality of image frames of the real-world scene. The digitized spatial representation may capture the spatial structure of objects in the real-world scene. The representation may further include visual characteristics of the objects mapped onto the volumetric reconstruction. The visual characteristics may include a texture, a pattern, a coloration, topographical features, other visual features. In some embodiments, the gaming module 114 may adjust rendering on a display of the client device 110 based on a pose of the client device 110. For example, a player may move around the digitized spatial representation with their client device 110. Based on the movement, i.e., the changed pose of the client device 110, the gaming module 114 may update a perspective of the digitized spatial representation. Accordingly, the gaming module 114 may leverage the pose, e.g., from the localization module 118.

The gaming module 114 can also control various other outputs to allow a player to interact with the game without requiring the player to view a display screen. For instance, the gaming module 114 can control various audio, vibratory, or other notifications that allow the player to play the game without looking at the display screen. The gaming module 114 can access game data received from the server 120 to provide an accurate representation of the game to the user. The gaming module 114 can receive and process player input and provide updates to the server 120 over the network 105. The gaming module 114 may also generate and/or adjust game content to be displayed by the client device 110. For example, the gaming module 114 may generate a virtual element based on depth information.

The positioning module 116 can be any device or circuitry for monitoring the position of the client device 110. For example, the positioning module 116 can determine actual or relative position by using a satellite navigation positioning system (e.g. a GPS system, a Galileo positioning system, the Global Navigation satellite system (GLONASS), the BeiDou Satellite Navigation and Positioning system), an inertial navigation system, a dead reckoning system, based on IP address, by using triangulation and/or proximity to cellular towers or Wi-Fi hotspots, and/or other suitable techniques for determining position. The positioning module 116 may further include various other sensors that may aid in accurately positioning the client device 110 location.

As the player moves around with the client device 110 in the real world, the positioning module 116 tracks the position of the player and provides the player position information to the gaming module 114. The gaming module 114 updates the player position in the virtual world associated with the game based on the actual position of the player in the real world. Thus, a player can interact with the virtual world simply by carrying or transporting the client device 110 in the real world. In particular, the location of the player in the virtual world can correspond to the location of the player in the real world. The gaming module 114 can provide player position information to the server 120 over the network 105. In response, the server 120 may enact various techniques to verifH the client device 110 location to prevent cheaters from spoofing the client device 110 location. It should be understood that location information associated with a player is utilized only if permission is granted after the player has been notified that location information of the player is to be accessed and how the location information is to be utilized in the context of the game (e.g., to update player position in the virtual world). In addition, any location information associated with players will be stored and maintained in a manner to protect player privacy.

The localization module 118 provides an additional or alternative way to determine the location of the client device 110. In one embodiment, the localization module 118 receives the location determined for the client device 110 by the positioning module 116 and refines it by determining a pose of one or more cameras of the camera assembly 112. The localization module 118 may use the location generated by the positioning module 116 to select a 3D map of the environment surrounding the client device 110 and localize against the 3D map. The localization module 118 may obtain the 3D map from local storage or from the server 120. The 3D map may be a point cloud, mesh, or any other suitable 3D representation of the environment surrounding the client device 110. Alternatively, the localization module 118 may determine a location or pose of the client device 110 without reference to a coarse location (such as one provided by a GPS system), such as by determining the relative location of the client device 110 to another device.

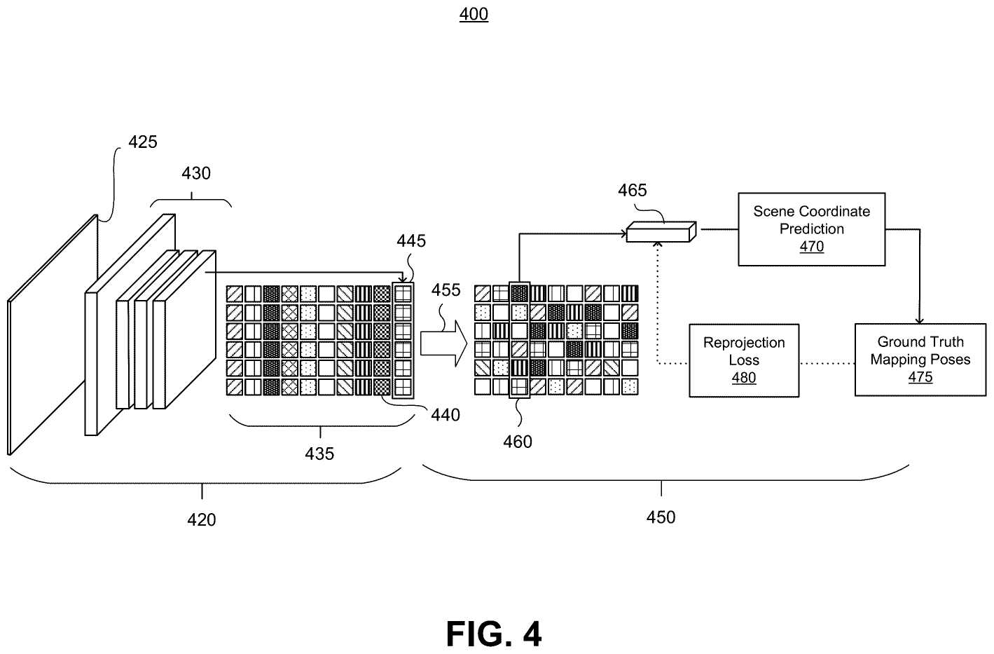

In one embodiment, the localization module 118 applies a trained relocalizer model (as an embodiment of a localization model) to determine the pose of images captured by the camera assembly 112 relative to the 3D map. Thus, the relocalizer model can determine an accurate (e.g., to within a few centimeters and degrees) determination of the position (e.g., up to three degrees of translational freedom) and orientation (e.g., up to three degrees of rotational freedom) of the client device 110. The position of the client device 110 can then be tracked over time using dead reckoning based on sensor readings, periodic re-localization, or a combination of both. Having an accurate pose for the client device 110 may enable the gaming module 114 to present virtual content overlaid on images of the real world (e.g., by displaying virtual elements in conjunction with a real-time feed from the camera assembly 112 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly. Additional embodiments of the relocalizer model are described in greater detail below with reference to FIGS. 4-8.

The server 120 can be any computing device and can include one or more processors and one or more computer-readable storage media. The computer-readable storage media can store instructions which cause the processor to perform operations. The server 120 can include or can be in communication with a database 115. The database 115 stores game data used in the parallel reality game to be served or provided to the client(s) 110 over the network 105.

The game data stored in the database 115 can include: (1) data associated with the virtual world in the parallel reality game (e.g. imagery data used to render the virtual world on a display device, geographic coordinates of locations in the virtual world, etc.); (2) data associated with players of the parallel reality game (e.g. player profiles including but not limited to player information, player experience level, player currency, current player positions in the virtual world/real world, player energy level, player preferences, team information, faction information, etc.); (3) data associated with game objectives (e.g. data associated with current game objectives, status of game objectives, past game objectives, future game objectives, desired game objectives, etc.); (4) data associated virtual elements in the virtual world (e.g. positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g. location of real-world objects/landmarks, description of real-world objects/landmarks, relevance of virtual elements linked to real-world objects, etc.); (6) Game status (e.g. current number of players, current status of game objectives, player leaderboard, etc.); (7) data associated with player actions/input (e.g. current player positions, past player positions, player moves, player input, player queries, player communications, etc.); and (8) any other data used, related to, or obtained during implementation of the parallel reality game. The game data stored in the database 115 can be populated either offline or in real time by system administrators and/or by data received from users/players of the system 100, such as from a client device 110 over the network 105.

The server 120 can be configured to receive requests for game data from a client device 110 (for instance via remote procedure calls (RPCs)) and to respond to those requests via the network 105. For instance, the server 120 can encode game data in one or more data files and provide the data files to the client device 110. In addition, the server 120 can be configured to receive game data (e.g. player positions, player actions, player input, etc.) from a client device 110 via the network 105. For instance, the client device 110 can be configured to periodically send player input and other updates to the server 120, which the server 120 uses to update game data in the database 115 to reflect any and all changed conditions for the game.

In the embodiment shown, the server 120 includes a universal game module 130, a commercial game module 140, a data collection module 150, an event module 160, and a training system 170. As mentioned above, the server 120 interacts with a database 115 that may be part of the server 120 or accessed remotely (e.g., the database 115 may be a distributed database accessed via the network 105). In other embodiments, the server 120 contains different and/or additional elements. In addition, the functions may be distributed among the elements in a different manner than described. For instance, the database 115 can be integrated into the server 120.

The universal game module 130 hosts the parallel reality game for all players and acts as the authoritative source for the current status of the parallel reality game for all players. As the host, the universal game module 130 generates game content for presentation to players, e.g., via their respective client devices 110. The universal game module 130 may access the database 115 to retrieve and/or store game data when hosting the parallel reality game. The universal game module 130 also receives game data from client device 110 (e.g. depth information, player input, player position, player actions, landmark information, etc.) and incorporates the game data received into the overall parallel reality game for all players of the parallel reality game. The universal game module 130 can also manage the delivery of game data to the client device 110 over the network 105. The universal game module 130 may also govern security aspects of client device 110 including but not limited to securing connections between the client device 110 and the server 120, establishing connections between various client device 110, and verifHing the location of the various client device 110.

The commercial game module 140, in embodiments where one is included, can be separate from or a part of the universal game module 130. The commercial game module 140 can manage the inclusion of various game features within the parallel reality game that are linked with a commercial activity in the real world. For instance, the commercial game module 140 can receive requests from external systems such as sponsors/advertisers, businesses, or other entities over the network 105 (via a network interface) to include game features linked with commercial activity in the parallel reality game. The commercial game module 140 can then arrange for the inclusion of these game features in the parallel reality game.

The server 120 can further include a data collection module 150. The data collection module 150, in embodiments where one is included, can be separate from or a part of the universal game module 130. The data collection module 150 can manage the inclusion of various game features within the parallel reality game that are linked with a data collection activity in the real world. For instance, the data collection module 150 can modify game data stored in the database 115 to include game features linked with data collection activity in the parallel reality game. The data collection module 150 can also analyze and data collected by players pursuant to the data collection activity and provide the data for access by various platforms.

The event module 160 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The training system 170 trains models implemented by the server 120. In one or more embodiments, the training system 170 may train relocalizer model for estimating a camera pose of an input image, in reference to reconstructed physical scene in the real-world. In one embodiment, the training system 170 trains a visual relocalizer in a multi-stage incremental process. In a first stage, the training system 170 trains the visual relocalizer using one or more initial images. The visual relocalizer is then used to register (i.e., estimate a camera pose for) a set of additional images. The visual relocalizer is then retrained using the additional images, with the process repeating with increasingly more images being registered until an end condition is met (e.g., a target accuracy is reached, a predetermined number of images have been registered, a measure of the difference in the trained relocalizer model between one iteration and the next is less than a threshold, etc.). In one or more embodiments, the training system 170 may train separate relocalizer models for different physical scenes. To provide functionality associated with a particular physical scene, the server 120 may identify which relocalizer model corresponds to the particular physical scene to leverage in providing the functionality.

In one embodiment, the visual relocalizer is an accelerated coordinate encoding (ACE) model that generates an estimated pose of the client device camera based on captured images of an environment. The relocalizer model may be trained using a process that is described in FIGS. 4-7. A trained relocalizer model is configured to generate an estimated pose of the camera based on received captured image data. In an embodiment, the server 120 deploys the one or more trained relocalizer models. In other embodiments, the trained relocalizer models may be deployed by a model serving system (not pictured). The relocalizer model may be provided to client devices 110 via an API or other communication protocols. The model serving system may be managed by another entity, and there may be different instances of the model serving system deploying a respective model (e.g., relocalizer model) deployed by a respective entity.

In other embodiments, a relocalizer model may be deployed on the client device 110. The trained relocalizer model may be provided to the client device 110 and the localization module 118 may include functionality to load and initialize the relocalizer model on the client device 110 to perform inference.

The content generation module 180 generates content for presentation to the client device 110. In one or more embodiments, the content generation module 180 may be used to generate virtual reality, mixed reality, augmented reality content, or other artificial reality content.

In one or more embodiments of generating augmented reality content, the content generation module 180 generates virtual elements to overlay onto images captured of real-world environments or scenes. The content generation module 180 may generate the virtual element based on information on the images, e.g., pose, camera calibration, depth, image features, etc. In some embodiments, the pose may be used in other image featurization models, e.g., a depth estimation model configured to input an image and its pose to output a depth map for the image. The depth map may inform depth of various objects in the image, e.g., for generating virtual content that is at least partially occluded.

In one or more embodiments, the content generation module 180 may generate a digitized spatial representation of a physical scene. To create the digitized spatial representation, the content generation module 180 reconstructs volumetric representations of real-world objects in the physical scene. The content generation module 180 may form the volumetric representations based on pose information on the image data and, optionally, associated depth information. For example, the content generation module 180 may implement a truncated signed distance function (TSDF) to integrate depth maps with known pose to generate a three-dimensional (3D) voxel array representing surfaces of objects in the real-world scene. The content generation module 180 may further extract a polygon mesh from the 3D voxel array to represent the surfaces via discretizing polygons. The content generation module 180 may further augment the spatial representation with visual characteristics of the objects, obtained from the image data. The content generation module 180 may store the generated spatial representations in the database 115. At a later time, the content generation module 180 may update or refine the spatial representation of the real-world scene with additional image data on the scene. In some embodiments, the content generation module 180 may generate virtual elements to interact with the digitized spatial representation. For example, the content generation module 180 may overlay virtual characters, virtual modifications, etc. The server 120 may provide the digitized spatial representation, optionally with virtual elements, to the client device 110 for presentation to the user.

In some embodiments, the content generation module 180 may generate navigational instructions for navigating a traversable agent within an environment. In such embodiments, the client device 110 may be the traversable agent, e.g., an autonomous vehicle. Based on its movement mode, the content generation module 180 may generate control instructions to control operation of one or more actuator assemblies to move the traversable agent. The content generation module 180 may receive sensory data of the environment, e.g., image data (and associated data), depth information, etc. The content generation module 180 (or the client device 110) may further implement models to extract additional features from the sensory data, e.g., implementing a trained relocalizer model to output poses for the images of the image data. The content generation module 180 may further implement a depth estimation model to output depth information for the images of the image data. The content generation module 180 may further implement other models, an object detection model for identifying and/or recognizing objects in the image data, a semantic segmentation model for segregating pixels into different pixel categorizations (e.g., objects, ground, sky, buildings, transient or moving objects, etc.), etc. Based on the information deduced from the sensory data, the content generation module 180 may determine the navigational route of the traversable agent. In some embodiments, the content generation module 180 may provide the navigational instructions to the client device 110. In other embodiments, the content generation module 180 may generate control instructions to control the movement of the traversable agent.

The network 105 can be any type of communications network, such as a local area network (e.g. intranet), wide area network (e.g. Internet), or some combination thereof. The network can also include a direct connection between a client device 110 and the server 120. In general, communication between the server 120 and a client device 110 can be carried via a network interface using any type of wired and/or wireless connection, using a variety of communication protocols (e.g. TCP/IP, HTTP, SMTP, FTP), encodings or formats (e.g. HTML, XML, JSON), and/or protection schemes (e.g. VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

In addition, in situations in which the systems and methods discussed herein access and analyze personal information about users, or make use of personal information, such as location information, the users may be provided with an opportunity to control whether programs or features collect the information and control whether and/or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### Exemplary Game Interface

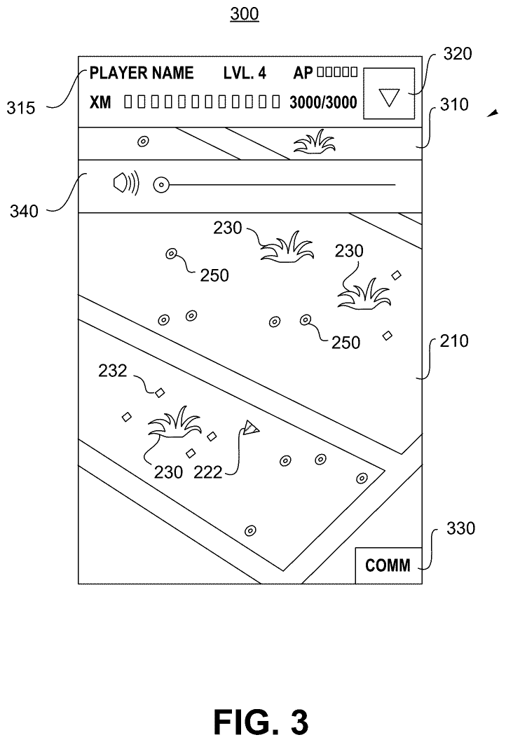

FIG. 3 depicts one embodiment of a game interface 300 that can be presented on a display of a client as part of the interface between a player and the virtual world 210. The game interface 300 includes a display window 310 that can be used to display the virtual world 210 and various other aspects of the game, such as player position 222 and the locations of virtual elements 230, virtual items 232, and virtual energy 250 in the virtual world 210. The user interface 300 can also display other information, such as game data information, game communications, player information, client location verification instructions and other information associated with the game. For example, the user interface can display player information 315, such as player name, experience level and other information. The user interface 300 can include a menu 320 for accessing various game settings and other information associated with the game. The user interface 300 can also include a communications interface 330 that enables communications between the game system and the player and between one or more players of the parallel reality game.

According to aspects of the present disclosure, a player can interact with the parallel reality game by simply carrying a client device 110 around in the real world. For instance, a player can play the game by simply accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 300 can include a plurality of non-visual elements that allow a user to interact with the game. For instance, the game interface can provide audible notifications to the player when the player is approaching a virtual element or object in the game or when an important event happens in the parallel reality game. A player can control these audible notifications with audio control 340. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

Those of ordinary skill in the art, using the disclosures provided herein, will appreciate that numerous game interface configurations and underlying functionalities will be apparent in light of this disclosure. The present disclosure is not intended to be limited to any one particular configuration.

### Supervised Training of Relocalizer Model

FIG. 4 is a conceptual diagram that depicts the training process of the relocalizer model, in accordance with one or more embodiments. Generally, a camera pose h can be estimated given a single RGB image I, based on the 3D scene coordinates generated by the relocalizer model and the corresponding 2D pixel positions of the input image. The camera pose is defined as a rigid body transformation that maps coordinates in a camera space e; to coordinates in a scene space yᵢ, therefore yᵢ=heᵢ. The camera pose can be estimated from the image-to-scene correspondences:

$$h = g ( C ) , with C = \{ ( {x}_{i} , {y}_{i} ) \} \qquad ( 1 )$$

where C is the set of correspondences between 2D pixel positions xᵢ and 3D scene coordinates yᵢ, and function g represents a robust pose solver, which may be a PnP minimal solver in a RANSAC loop followed by refinement.

Scene coordinate regression may be used to obtain image-to-scene correspondences. A function f (e.g., relocalizer model) to predict 3D scene points for any 2D image location is learned, represented by:

$${y}_{i} = f ( {p}_{i} ; w ) , with {p}_{i} = P ( {x}_{i} , I ) \qquad ( 2 )$$

where f is parametrized by learnable weights w. The function f receives an image patch pᵢ extracted around pixel position xᵢ from mapping image/and produces a 3D coordinate yᵢ. Thus, f implements a mapping from patches to coordinates, f: R^{C}^{₁}^{×H}^{ₚ}^{×W}^{ₚ}→R³.

In the example relocalizer model depicted in FIG. 4, the relocalizer model is a coordinate regression model that includes a convolutional network and a regression head. The convolutional network 430 may be implemented using a scene-agnostic convolutional network, and the regression head 465 may be implemented as a scene specific regression multi-layer perceptron (MLP) head. The overall model is represented by:

$$f ( {p}_{i} ; w ) = {f}_{H} ( {f}_{i} ; {w}_{H} ) , with {f}_{i} = {f}_{B} ( {p}_{i} ; {w}_{B} ) \qquad ( 3 )$$

where f_{B} is the convolutional network 430 that predicts a high-dimensional feature fᵢ with dimensionality C_{F}, and f_{H} is the MLP regression head 465 that predicts 3D scene coordinates yᵢ based on the feature fᵢ. This can be further represented by:

$${f}_{B} : {R}^{{C}_{I} \times {H}_{P} \times {W}_{P}} \to {R}^{{C}_{f}} and {f}_{H} : {R}^{{C}_{f}} \to {R}^{3} \qquad ( 4 )$$

where f_{B} outputs a feature tensor, and f_{H} processes the feature tensor to generate the scene coordinates. RGB images or grayscale images with Cₗ=1 may be used as input. The training process of the relocalizer model is explained below.

In general, the relocalizer model is learned by optimizing over all mapping images IM with the ground truth poses hᵢ^{*} as supervision, represented below:

$${arg min}_{w} {\sum }_{I ∈ {I}_{M}} {\sum }_{I} {l}_{π} [ {x}_{i} , {f ( {p}_{i} ; w )}^{︷ {y}_{i}} , {h}_{i}^{*} ] \qquad ( 5 )$$

where l_{π} is a reprojection loss. Equation 5 is optimized using minibatch stochastic gradient descent, which updates the model parameters based on the gradient of loss with respect to a small subset of the training data. The neural network predicts dense scene coordinates from one mapping image at a time, with all predictions supervised using the ground truth mapping pose.

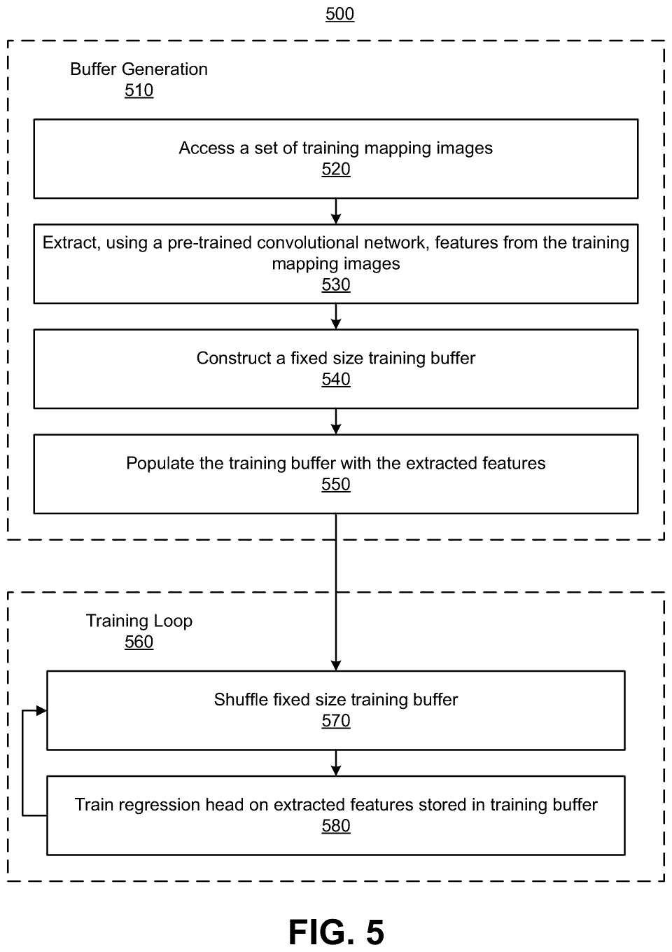

In an embodiment, the relocalizer model is trained in two stages, the first stage including pre-training the convolutional network, and the second stage including training the MLP regression heads on a new scene. For the first stage, a training system pre-trains the convolutional network 430 on input images from different environments, the convolutional network 430 trained on an N number of scenes in parallel. The convolutional network 430 may be trained using image-level training and curriculum training, with a pixel-wise reprojection loss function. This is described in further detail below in the description of FIG. 5.

For the second stage, the training system trains the one or more MLP regression heads 465 attached to the convolutional network, each MLP regression head on a new scene. The training process of the MLP regression heads 465 can be further divided into two stages, the buffer generation stage 420 and the main training loop 450. In the buffer generation stage 420, a fixed sized training buffer 435 is constructed. The training system constructs the training buffer 435 by passing the mapping images 425 through the convolutional network 430 that extracts high-dimensional feature vectors. Each feature 440 is represented by a box in the training buffer 435, and features from the same mapping image 445 are illustrated with a similar pattern fill. The training buffer 435 is generated once in the first minute of training.

The main training loop 450 outlines the training process for the scene specific MLP regression heads 465 on new scenes, the regression heads 465 configured to predict the scene coordinates based on features generated by the convolutional network. At the beginning of each epoch, the training buffer 435 is shuffled 455 to mix features 440 (e.g., patches) across all mapping data. At each training step, training batches 460 are constructed with several thousand random features and the associated mapping poses, and a parameter update over thousands of mapping views is computed at once. By randomizing the patches over the entire training set and constructing training batches from many different mapping views, the gradients are decorrelated within a batch and leads to a very stable training signal, robustness to high learning rates, and fast convergence. This also increases efficiency for gradient computation for the MLP regression head 465.

The MLP regression head 465 makes a scene coordinate prediction 470. A tanh-based pixel-wise reprojection loss function is used to calculate a reprojection loss 480, which measures the difference between the predicted scene coordinates and the ground truth scene coordinates 475. The reprojection loss is used to train the MLP regression head 465 to minimize error between the predicted scene coordinates and the ground truth scene coordinates.

FIG. 5 is a flowchart that describes a method for training the scene-specific regression head network, in accordance with one or more embodiments. The method 500 yields a trained MLP regression head that generates predicted scene coordinates for the image pixels. The steps of FIG. 5 are illustrated from the perspective of a training system performing the method 500. However, some or all of the steps may be performed by other entities and/or components. In addition, some embodiments may perform the steps in parallel, perform the steps in different orders, or perform different steps.

Prior to method 500, as described in FIG. 4, the convolutional network 430 is pre-trained using a set of training mapping images. The convolutional network 430 may be any dense feature description network with descriptors that are distinctive for any position in the input image. In an embodiment, the network architecture consists of the first N number of layers (e.g., N=10, including skip connections) of the DSAC* network design.

The convolutional network 430 is trained on a set of training mapping images with N regression heads for N scenes, in parallel. For example, the convolutional network 430 may be trained on one hundred scenes in parallel by attaching one hundred regression heads to its end. The set of training mapping images may be acquired from users. The training images may be collected while users scan wayspots or other locations of interest while playing games, or from any relevant third-party entity (e.g., developers interested in using the relocalization service API). The set of training images contains images from multiple scenes. A portion of the set of training images may be heavily augmented, through various methods such as brightness and contrast jitter, saturation and hue jitter, image warping and random re-scaling of images. The network may be trained with half-precision floating point weights.

In an embodiment, the convolutional network 430 is trained using an image-level training approach, and is combined with curriculum training to mimic end-to-end training. Accordingly, the network can focus on good predictions and neglect less precise predictions that would be filtered by RANSAC during pose estimation. The training loss based on the pixel-wise reprojection loss is represented by:

$$\begin{matrix}{l}_{π} [ {x}_{i} , {y}_{i} , {h}_{i}^{*} ] = \{ {\hat{e}}_{π} ( {x}_{i} , {y}_{i} , {h}_{i}^{*} ) & if {y}_{i}\end{matrix} \qquad ( 6 )$$

$$\begin{matrix}∈ V {‖ {y}_{i} - {\underline{y}}_{i} ‖}_{0} & Otherwise\end{matrix} .$$

where a robust reprojection error ê_{π} is optimized for all valid coordinate predictions V. Valid predictions are within a range (e.g., 10 cm and 1000 m) in front of the image plane, and have a reprojection error below a threshold (e.g., 1000 px). For invalid predictions, the reprojection loss optimizes the distance to a dummy scene coordinate y; that is calculated from the ground truth camera pose assuming a fixed image depth (e.g., 10 m). Accordingly, the pre-trained network is used to extract dense descriptors on any new scene, the extracted descriptors used to train the regression heads, described below by method 500.

As described in FIG. 4, the MLP regression heads 465 are trained during a second stage of training which is depicted by FIG. 5. In an embodiment, the MLP regression head 465 is composed of 8 1×1 convolutional layers, of width 512, with skip connections after layer 3 and 6; followed by a final 1×1 convolutional layer that produces the scene coordinates. The regression head layers may use half-precision floating point weights. The MLP regression heads may be configured to directly regress the scene coordinates or regress homogenous coordinates. In the former case, the last layer would output a 3-channel tensor, while in the latter case, the last layer would output a 4D tensor (\dot{x}, \dot{y}, ż, ŵ), with \dot{y}=(\dot{x}, \dot{y}, ż)^{T} being the homogeneous representation of the 3D scene coordinates, and ŵ ∈R being an unnormalized homogeneous parameter. w ∈R⁺ is calculated from ŵ by applying a biased and clipped Softplus operator to ŵ, and the scene coordinates are subsequently de-homogenized. Specifically, w may be calculated as follows:

$$w = ( \frac{1}{{S}_{min}} , {β}^{- 1} \cdot log log ( 1 + exp exp ( β \cdot \hat{w} ) ) + \frac{1}{{S}_{max}} ) \qquad ( 7 )$$

where Sₘᵢₙ and Sₘₐₓ are used to clip the scale factor determined by w, and β is a parameter used to ensure that when the network outputs ŵ=0, the resulting homogeneous parameter w=1.

Accordingly, the network is steered towards producing a neutral homogeneous parameter, wherein it is centered on 1. In an embodiment,

$$β = \frac{log ( 2 )}{1 - {S}_{max}^{- 1}} .$$

The output of the network is de-homogenized into the tensor y containing 3D scene coordinates:

$$y = \frac{\dot{y}}{w} \qquad ( 8 )$$

For both the cases of direct regression the scene coordinates and regression of homogenous coordinates, the coordinates output by the network are learned relatively to the “mean” translation of the camera poses associated to the mapping frames for numerical stability.

As described in FIG. 5, the MLP regression head network may be trained in two stages: a buffer generation stage 510, and a main training loop 550. During the buffer generation stage 510, the training system accesses 520 a set of training mapping images depicting new scenes to be mapped. The training images are augmented using a similar approach that is used in the convolutional network training. The training images may be augmented with different (e.g., weaker) data augmentation parameters, if the convolutional network was already trained on strongly augmented images.

The training system provides the training mapping images to the pre-trained convolutional network, which extracts 530 features from the training images. The training system constructs 540 a fixed size training buffer. For example, the buffer may contain 8 million 512-channel patch descriptors, along with the associated 2D location in the source image, mapping camera pose, and intrinsic parameters. The training system populates 545 the training buffer with extracted high-dimensional feature vectors produced by the convolutional network. For each training mapping image processed by the convolutional network, an M number (e.g., M=1024) of patches and corresponding feature descriptors are randomly selected to be copied into the training buffer, along with other metadata (e.g., 2D patch location, camera pose and intrinsics). In another embodiment, feature selection is not random, and instead, the features may be assigned a score (or weight) computed by the relocalizer model. For example, the relocalizer model may assign different scores to different features in an image, allowing it to emphasize important information. Accordingly, the features selected to be copied into the training buffer may have a higher score assigned compared to other features. Thus, the regression heads are trained on more important regions of the image.

During the main training loop 550, at the beginning of each epoch, the training buffer is shuffled 560 to mix features (or patches) across all mapping data. The regression head is trained 570 on extracted features stored in the training buffer. As described above, the regression head is trained by repeatedly iterating over the shuffled training buffer. Shuffling the training buffer randomizes patches over the entire training set, and constructs training batches from many different mapping views. Accordingly, reducing correlation between gradients within a batch, and leading to a stable training signal, robustness to high learning rates, and, ultimately, fast convergence. In one embodiment, the regression head is trained for sixteen epochs to achieve state-of-the-art accuracy in five minutes or less.

As described in FIG. 4, the MLP regression heads 465 may be trained using a tanh-based loss function on reprojection errors. The function may be dynamically rescaled according to a circular schedule with a threshold decreasing throughout the length of the training process. This is represented below:

$${\hat{e}}_{π} ( {x}_{i} , {y}_{i} , {h}_{i}^{*} ) = τ ( t ) tanh tanh ( \frac{{e}_{π} ( {x}_{i} , {y}_{i} , {h}_{i}^{*} )}{τ ( t )} ) \qquad ( 9 )$$

where τ represents a threshold of reprojection error e_{π}. The tanh function is dynamically rescaled according to the threshold t that varies throughout training, represented below:

$$τ ( t ) = w ( t ) {τ}_{max} + {τ}_{min} , with w ( t ) = \sqrt{1 - {t}^{2}} \qquad ( 10 )$$

where t ∈(0, 1) denotes the relative training progress. This curriculum implements a circular schedule of threshold τ, which remains close to τₘₐₓ at the beginning of training, and declines towards τₘᵢₙ at the end of training.

Additionally, the entire network may be trained with half-precision floating point weights, which results in an additional speed boost. The neural networks may also be stored with float16 precision, which allows an increase in the depth of our regression heads while maintaining small (e.g., 4 MB) maps. In conjunction with the curriculum training, a one cycle learning rate schedule can be used (e.g., increasing the learning rate in the middle of training and reducing it towards the end). An advantage was observed in overparameterizing the scene coordinate representation by predicting the homogeneous coordinates y′=(x, y, z, w)^{T} and applying a w-clip, enforcing w to be positive by applying a Softplus operation.

### Self-Supervised Incremental Training of Relocalizer Model

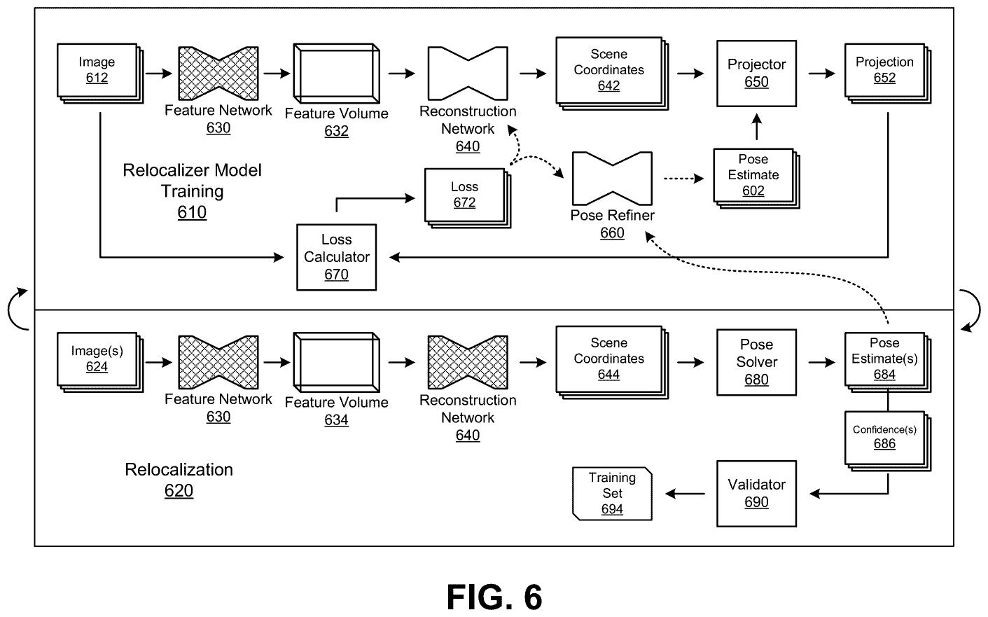

FIG. 6 is a conceptual diagram of self-supervised incremental training of a relocalizer model, in accordance with one or more embodiments. A training system (e.g., the training system 170) is described as performing the various steps in the self-supervised incremental training of the relocalizer. In other embodiments, other entities (e.g., another device or another system) may perform some of the steps. In embodiments, the training system may iteratively train the relocalizer model until one or more stopping conditions are met, yielding the trained relocalizer model.

The relocalizer model generally comprises a feature network 630, which is connected to a reconstruction network 640, and which is connected to a pose solver 650. In general, the feature network 630 is configured to extract image features from an input image, the reconstruction network 640 is configured to regress from the image features scene coordinates corresponding spatial coordinates of pixel features captured in the image, and the pose solver 650 is configured to recover the camera pose based on the scene coordinates. Generally, the relocalizer model is configured to estimate camera parameters, e.g., intrinsic parameters and/or extrinsic parameters including the camera pose. In other embodiments, the relocalizer model may further be configured to input the intrinsic parameters to the estimate the extrinsic parameters.

The relocalizer model also recovers the three-dimensional (3D) reconstruction of the scene, which is used by the reconstruction network 640 to generate scene coordinates for an input image. Each pixel j in image i with 2D pixel position pᵢⱼ has a corresponding coordinate in the 3D reconstruction of the scene. The relocalizer model effectively identifies the 2D-to-3D correspondences, related by the camera pose and the projection function T:

$${p}_{ij} = π ( {K}_{i} , {T}_{i} , {y}_{ij} ) \qquad ( 11 )$$

where Kᵢ is a matrix representing the camera's intrinsic parameters, Tᵢ is a matrix representing the camera's extrinsic parameters including the pose, and yᵢⱼ represents the 3D coordinates of the pixel.

The relocalizer model leverages a learnable function f_{SCR} that maps an image patch of image lᵢ, centered around pixel position pᵢⱼ to a scene coordinate:

$${y}_{ij} = {f}_{SCR} ( {p}_{ij} , {I}_{i} ) \qquad ( 12 )$$

Moreover, with the 2D-to-3D correspondences, the relocalizer model can recover the pose Tᵢ with a pose solver g:

$${T}_{i} = g ( {K}_{i} , \{ ( {p}_{ij} , {y}_{ij} ) \} ) \qquad ( 13 )$$

The pose solver function g may further combine a Perspective-n-Point (PnP) solver with a Random Sample Consensus (RANSAC) loop. The perspective-n-point (PnP) solver is a computer vision algorithm that estimates the pose (position and orientation) of the camera relative to the 3D reconstruction, given a set of corresponding 3D points in the scene and their 2D projections in the image captured by the camera. RANSAC is an optimization algorithm used to estimate parameters of a mathematical model from a set of observed data that contains outliers. In such example, the RANSAC algorithm seeks to identify the optimal pose, considering any potential inaccuracies or incorrect predictions in the 2D-to-3D correspondences.

The training system initially obtains image data captured by one or more cameras of a real-world scene. The image data may include individual image frames and/or image frames extracted from video. The training system obtains the images of the image data. Each image may include camera intrinsic parameters, characterizing the camera that captured the image. The training system may perform some initial preprocessing on the images, e.g., to remove images that may be unusuable for training.

To perform the self-supervised incremental training, the training system alternates between a phase of relocalizer model training 610 (also referred to as “neural mapping”) and a phase of relocalization 620 to predict pose estimates for additional images (which serve as pseudo ground truth to guide training of the relocalizer model). As the relocalizer is implemented in the relocalization 620 phase to predict pose estimates for additional images, the training system may leverage the pose estimates for self-supervised training of the relocalizer model, incrementally improving the relocalizer's pose prediction capabilities. Such methodology is advantageous in that the training can be performed without ground truth pose data. This is particularly helpful in situations where image data may exist without the ground truth pose data, yet the methodology empowers leveraging of the image data, nonetheless, in training the relocalizer model. Moreover, the incremental training quickens training through the incremental training steps. As compared to a traditional training methodology that would perform fitting of regressed scene coordinates across a large quantity of image data (i.e., sufficient to robustly train the relocalizer model), the self-supervised incremental training approach employs a lot of compact, quick training steps that may yield a coarsely trained relocalizer model, in the interim training stages, but resulting in a robust and accurate relocalizer model upon training completion.

The training system identifies an initial subset of the image data to use as an initial seed in a first stage of training of the relocalizer model. In some embodiments, the initial subset includes one image or multiple images. In some embodiments, one or more of the images in the image data may include relative pose information, e.g., recorded by the camera in the camera's reference coordinate system. In general, the self-supervised training is agnostic of the ground truth pose. The training system uses the initial subset including at least an initial image 612. The initial image 612 may be chosen at random from the image data of the real-world scene. The training system may initialize a pose estimate 602 for the initial image 612. In one or more embodiments, the training system may set the pose estimate 602 of the initial image 612 used in a first training stage to be an identity pose. In general, a pose is a relative transformation between two perspectives of an observer. As such, the identity pose establishes the pose of the initial image 612 as the reference point of the observer. The identity pose is, thus, a transformation that identifies the relative pose of the initial image 612 as identical to the reference point, i.e., no transformation.

The training system inputs the initial image 612 into a feature network 630 to extract a feature volume 632 comprising image features from the initial image 612. The feature network 630 may be a pre-trained convolutional neural network with parameters fixed during training of the relocalizer model. The feature network 630 is an embodiment of the feature convolutional network 430 described in FIG. 4. In other embodiments, the training system may further train (i.e., adjust parameters of the feature network 630) during training of the relocalizer model. The feature volume 632 may be multidimensional, concatenating features across a set of input images. In general, a subset of dimensions correspond to the dimensionality of the training images, e.g., if training with multiple images, one dimensionality of the feature volume 632 may correspond to the number of images, whereas another two dimensions of the feature volume 632 correspond to the pixel dimensions of each training image. Moreover, the feature volume 632 may include a plurality of channels for different feature types. In one or more embodiments, with an initial seed set of two or more images, the feature network 630 may output features for each input image 612.

In one or more embodiments, the training system may perform data augmentation to modify the feature volume 632 to prevent overfitting of the reconstruction network 640. To perform the data augmentation, the training system may identify a random set of channels in the feature volume 632 to drop out, effectively sparsing the signal in the feature volume 632, making the reconstruction network 640 more robust in predictability.

The training system inputs the feature volume 632 into the reconstruction network 640 to output (i.e., to reconstruct) scene coordinates 642 for the input image 612. The scene coordinates 624 represent spatial positions of the pixels of the input image 612. For example, the reconstruction network 640 outputs a set of coordinates in the 3D reconstruction for one pixel for a first object at a shallow depth in the input image 612. Accordingly, the scene coordinates represent a 2D-to-3D correspondence between the pixel in the input image 612 to its spatial coordinates in the 3D reconstruction. The reconstruction network 640 does likewise for the other pixels of the input image 612. In some embodiments, the reconstruction network 640 may be configured to output a confidence for scene coordinates 642, providing further insight for downstream analyses with the scene coordinates 642. In one or more embodiments, with an initial seed set of two or more images, the reconstruction network 640 may output scene coordinates 642 for pixels of each input image 612.

The projector 650 is configured to input the scene coordinates 642 for pixels of the initial image 612 and the pose estimate 602, i.e., the identity pose (as pseudo ground truth), to output the projection 652. The projection is a reconstructed frame corresponding to the initial image 612. The projection is effectively reconstructing the view of the image 612 based on the 3D scene reconstruction and the camera pose of the image 612. In one or more embodiments, with an initial seed set of two or more images, the projector 650 may project a projection 652 per input image 612.

The loss calculator 670 computes a loss 672 as a pixel-wise projection error between the initial image 612 and the projection 652. In one or more embodiments, with an initial seed set of two or more images, the loss calculator 670 may calculate a loss 672 per pair of image and projection.

The training system trains the reconstruction network 640 based on the loss 672. Training the reconstruction network 640 may entail adjusting parameters of the reconstruction network 640 to minimize the loss 672. In some embodiments, the training system may train one or more networks in conjunction. In other embodiments, the training system may train the networks individually. In such embodiments, the training system may fix parameters of networks not being trained, while only adjusting parameters, i.e., training, of one network. Once the network is sufficiently trained, i.e., for some set of training data, or upon achieving some target metric, then the training system may fix the parameters of the trained network whilst moving onto training the next network.

After the first stage of training the relocalizer model (e.g., trained on the initial image 612), the training system performs relocalization 620. In performing relocalization 620, the training system applies the trained relocalizer model to a subsequent set of one or more images 624 to predict pose estimates 684 for the subsequent set of images 624. As with the initial image 612, the one or more images 624 may or may not have ground truth poses. The feature network 630 is applied to output a feature volume 634 for the images 624. The reconstruction network 640 is applied to output scene coordinates 644 for pixels of the images 624. The pose solver 680 extracts the pose estimates 684 for the images 624 based on the images 624 and the scene coordinates 644. The pose solver 680 may apply a PnP algorithm to solve the pose based on the images 624 and the scene coordinates 644 for an image. The pose solver 680 may further apply a RANSAC algorithm in solving the pose. In one or more embodiments, the pose solver 680 is configured to output confidences 686 associated with the pose estimates 684. The confidences 686 may correlate with the corroboration of the scene coordinates in solving the pose estimate 684. For example, if the scene coordinates 684 are highly variable in their accuracy, the resultant pose estimate 684 output by the pose solver 680 might also lack a high degree of confidence. The validator 690 assesses the pose estimates 684 of the images 624 by evaluating their confidences 686 against a confidence threshold. The validator 690 filters out or excludes images with a pose estimate 684 associated with a low confidence. Images with pose estimates above the confidence threshold are retained in a training set 694 for the next training stage. In some embodiments, with ground truth pose data for one or more images, the validator 690 may compare the pose estimates 694 against the ground truth poses. Images with pose estimates with an error calculated against the ground truth pose below an error threshold may be retained in the training set 694.

In a subsequent stage of relocalizer model training 610, the training system leverages the training set 694 with the selected images 624 and their corresponding pose estimates 684. The training system applies the images in the training set through the feature network 630 and the reconstruction networks 640 to yield the scene coordinates 642. At the projection step, the training system may leverage a pose refiner 660 to refine pose estimates 684 from prior iterations of relocalization 620. The pose refiner 660 may be structured as a multi-layer perceptron, or any analogous machine-learning model. The pose refiner 660 takes a prior pose estimate to yield a refined pose estimate. The pose refiner 660 may implement a refinement function f_{Pose}^{t}:

$${T}_{i}^{t} = {f}_{Pose}^{t} ( {\tilde{T}}_{i}^{t} ) \qquad ( 14 )$$

where Tᵢ^{t} denotes the initial pose estimate at the start of a mapping iteration. The refinement function f_{Pose}^{t} ingests the initial pose estimate as a matrix cross product between the positional transformations and the rotational transformations, to predict the refined pose estimate. The refined pose estimate may be provided to the projector 650 in generating the projection 652. The loss 672 calculated by the loss calculator is then leveraged in training (i.e., tuning) the reconstruction network 640 and the pose refiner 660. In one or more embodiments, the pose refiner 660 may further implement a weight decay factor biasing the pose refiner 660 to make small updates.

As the training system alternates between relocalizer model training 610 (i.e., neural mapping) and relocalization 620, the training system incrementally refines the 3D reconstruction of the physical scene with additional points from additional images. The training system also incrementally refines the reconstruction network 640 and the pose refiner 660 in additional training stages. In one or more embodiments, the training system may dynamically adjust a learning rate schedule that controls the learning rate at each stage of training. The learning rate controls the magnitude of parameter adjustment during training. For example, a high learning rate provides for large parameter adjustments, e.g., typically useful in early training stages, whereas a low learning rate provides for smaller parameter adjustments, e.g., typically useful in late training stages. In some embodiments, the learning rate schedule is fixed, e.g., which may include a fixed period followed by a steady decay. In other embodiments, the training system may periodically validate the predictive accuracy of the relocalizer model. If the predictive accuracy has yet to achieve a target metric, then the training system may cycle the learning rate schedule to jumpstart the learning process.

In some embodiments, the training system may initialize (i.e., perform a first stage of training) a plurality of relocalizer models with different seed images from the training image data set. The training system may evaluate the relocalizer models in their infancy to identify one or more top performers. For example, the training system may rank the relocalizer models based on their predictive accuracy after the initial training stage (or some small number of training stages). From the ranking, the training system may identify the top performers. The training system may proceed with the top performers in subsequent training stages. This process of leveraging a plurality of relocalizer models is computationally cheap, as the initial training stages use limited image data. However, the upside is identifying an optimal start point in the incremental training process.

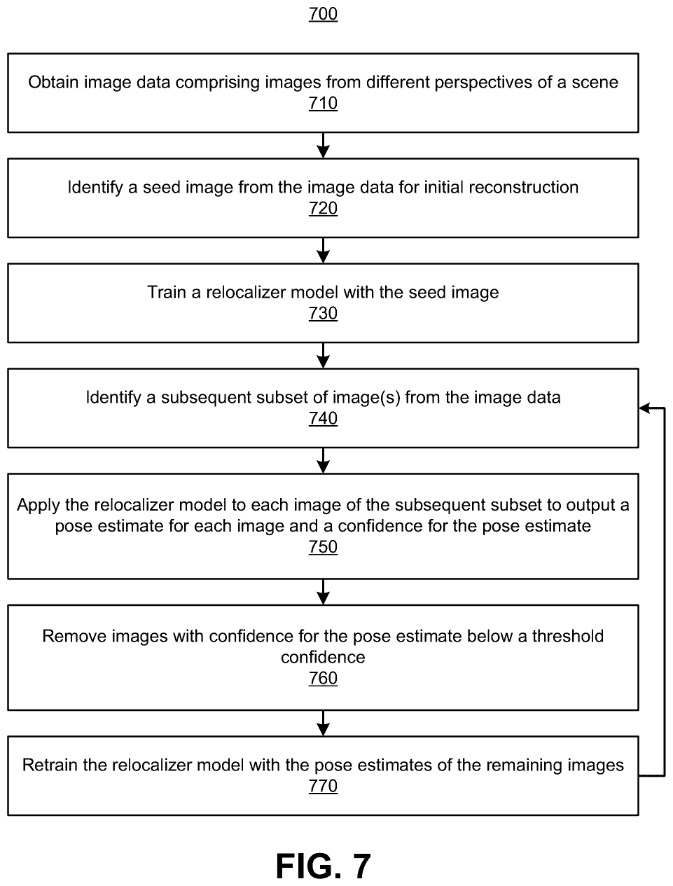

FIG. 7 is a flowchart that describes the method 700 of self-supervised incremental training of a relocalizer model, in accordance with one or more embodiments. The method 700 results in a trained relocalizer model. The steps of FIG. 7 are described from the perspective of a training system. However, some or all of the steps may be performed by other entities and/or components. In addition, some embodiments may perform the steps in parallel, perform the steps in different orders, or perform different steps.

The system obtains 710 image data comprising images from different perspectives of a scene. The image data may be captured by different camera assemblies over different sessions, e.g., by different client devices. The image data depict the same scene.

The system identifies 720 a seed image from the image data for initialization of the relocalizer model. The system may randomly select the initial training image from the image data. In some embodiments, the system initializes a plurality of seed models, wherein each seed model is trained on a different, e.g., randomly selected, seed image from the image data.

The system trains 730 the relocalizer model with the seed image. The relocalizer model includes at least a reconstruction network, but may further include a feature network. In training with the seed image, the system establishes the pose of the seed image to be the identity pose, effectively establishing the pose of the seed image as the reference pose for the relocalization task. In training, the system applies a reconstruction network to output scene coordinates describing spatial positions (three-dimensional) of pixels associated with objects in the real-world scene. The reconstruction network effectively is generating and storing a 3D reconstruction of the scene, with which the reconstruction network can regress scene coordinates for novel views. The system projects the scene coordinates back into a two-dimensional projection based on the identity pose. The system computes a loss as a pixel-wise projection error between corresponding pixels of the two-dimensional projection and pixels of the seed image.

In each subsequent training iteration, the system identifies 740 a subsequent set of images from the image data. The subsequent set may also be randomly selected. The images in the subsequent have not been registered into the scene reconstruction.

The system applies 750 the relocalizer model to each image of the subsequent subset to output a pose estimate for each image and a confidence for the pose estimate. In applying the relocalizer model, the reconstruction network and/or the feature network is applied to yield scene coordinates for pixels of the image. The relocalizer model includes a pose solver that computes the camera pose or the pose estimate based on the scene coordinates. The pose solver may further output the confidence. The pose solver may combine a PnP algorithm and a RANSAC loop.

The system removes 760 images with confidence for the pose estimate below a threshold confidence. The system prunes the subsequent sets to ensure poor pose estimates are not used as pseudo ground truth in training the relocalization model. In other embodiments, the system may evaluate the pose estimate against a ground truth pose for one or more of the images. In such embodiments, the sparse ground truth pose data can serve as pose hints to the relocalizer training.

The system retrains 770 the relocalizer model with the pose estimates of the remaining images. The system performs a similar process to the subsequent set of images as with the initial seed image. The system projects the scene coordinates for the image based on the pose estimate into a 2D projection, which is then used to compute loss against the image. The system may further leverage feature dropout. The system may further implement a pose refinement network to modify or to refine pose estimates output by the relocalizer model on previously registered images.

The system may continue the iterative, incremental training until the system determines that an end condition is met, e.g., based on the performance of the relocalizer model. In some embodiments, the system may implement a dynamic learning rate schedule that periodically assesses the model's performance to dynamically adjust the learning rate.

### Deployment of Relocalizer Model

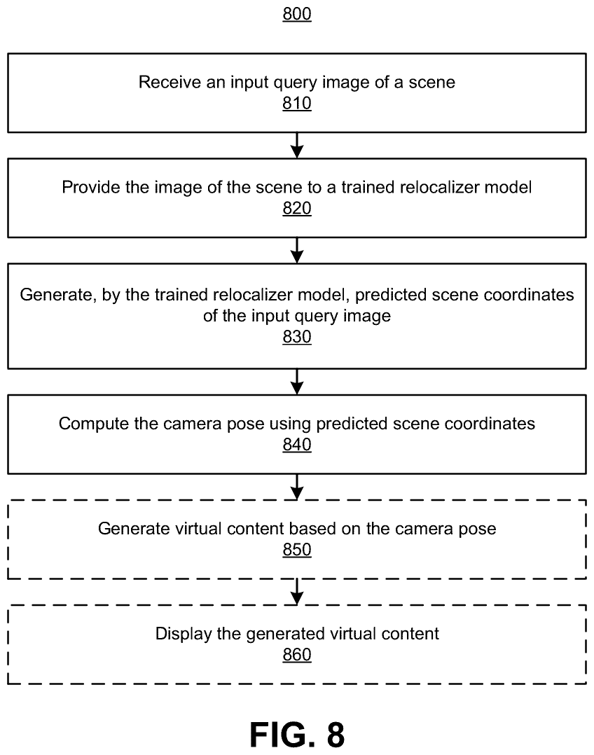

FIG. 8 is a flowchart that describes the generation of camera poses, according to one or more embodiments. The method 800 results in an estimated pose for an input query image. The steps of FIG. 8 are illustrated from the perspective of the game server and a client device performing the method 800. However, some or all of the steps may be performed by other entities and/or components. In addition, some embodiments may perform the steps in parallel, perform the steps in different orders, or perform different steps.

The client device receives 810 an input query image of a scene. The input query image (e.g., RGB image) may be captured by the camera assembly 112 of the client device 110. The input query image may also have intrinsics corresponding to the geometric properties of the camera that captured the image. The client device provides 820 the input query image to a trained relocalizer model. As described above, the relocalizer model may be trained by a training system, e.g., via the method described in FIG. 5. The relocalizer model receives the input query image, and, in some embodiments, the intrinsics of the image. The trained relocalizer model generates 830 predicted scene coordinates for the image pixels, producing the correspondence between the 3D scene coordinates and the 2D pixel positions.

The training system computes 840 the camera pose using the predicted scene coordinates generated by the relocalizer model. As described in FIG. 4, a camera pose h is calculated using a robust pose solver g using the correspondence between the 3D scene coordinates and the pixels of the image. The pose solver may include a PnP minimal solver in a RANSAC loop, or other known algorithms, and is followed by refinement. Refinement consists iterative optimization of the reprojection error over all RANSAC inliers using a known optimization algorithm, such as Levenberg-Marquardt.

The training system returns the resulting camera pose to the client device over the network. The relocalizer module may provide the camera pose to the gaming module to generate 850 virtual content for a parallel reality game. The client device 110 displays 860 the image of the scene or a constant video feed augmented with the virtual content to a user. For example, a physical object may be augmented with virtual content that interacts with the physical object.

### Example Computing System

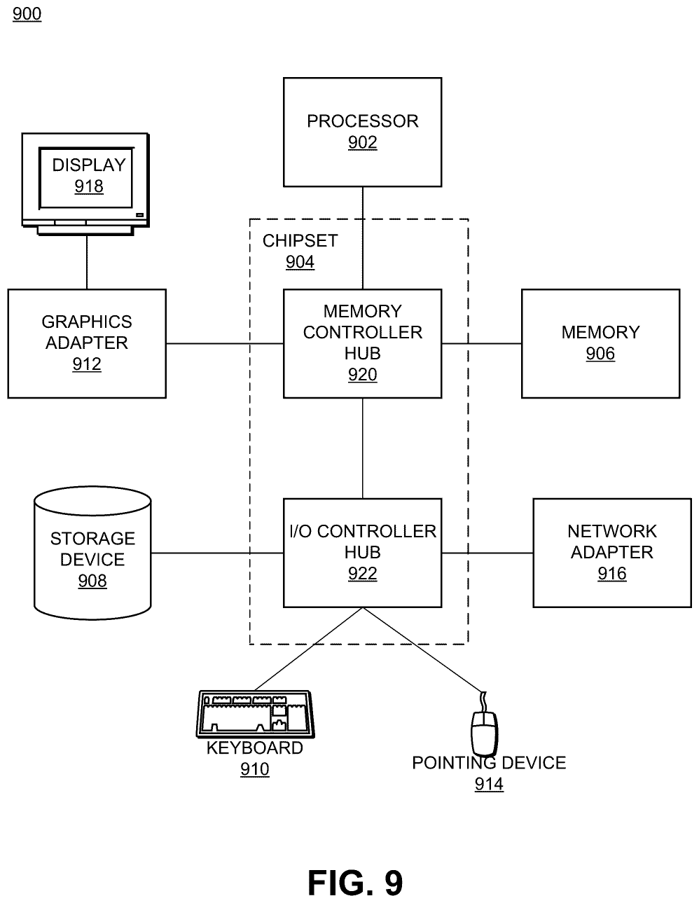

FIG. 9 is an example architecture of a computing device, according to an embodiment. Although FIG. 9 depicts a high-level block diagram illustrating physical components of a computer used as part or all of one or more entities described herein, in accordance with an embodiment, a computer may have additional, less, or variations of the components provided in FIG. 9. Although FIG. 9 depicts a computer 900, the figure is intended as functional description of the various features which may be present in computer systems than as a structural schematic of the implementations described herein. In practice, and as recognized by those of ordinary skill in the art, items shown separately could be combined and some items could be separated.

Illustrated in FIG. 9 are at least one processor 902 coupled to a chipset 904. Also coupled to the chipset 904 are a memory 906, a storage device 908, a keyboard 910, a graphics adapter 912, a pointing device 914, and a network adapter 916. A display 918 is coupled to the graphics adapter 912. In one embodiment, the functionality of the chipset 904 is provided by a memory controller hub 920 and an I/O hub 922. In another embodiment, the memory 906 is coupled directly to the processor 902 instead of the chipset 904. In some embodiments, the computer 900 includes one or more communication buses for interconnecting these components. The one or more communication buses optionally include circuitry (sometimes called a chipset) that interconnects and controls communications between system components.

The storage device 908 is any non-transitory computer-readable storage medium, such as a hard drive, compact disk read-only memory (CD-ROM), DVD, or a solid-state memory device or other optical storage, magnetic cassettes, magnetic tape, magnetic disk storage or other magnetic storage devices, magnetic disk storage devices, optical disk storage devices, flash memory devices, or other non-volatile solid state storage devices. Such a storage device 908 can also be referred to as persistent memory. The pointing device 914 may be a mouse, track ball, or other type of pointing device, and is used in combination with the keyboard 910 to input data into the computer 900. The graphics adapter 912 displays images and other information on the display 918. The network adapter 916 couples the computer 900 to a local or wide area network.

The memory 906 holds instructions and data used by the processor 902. The memory 906 can be non-persistent memory, examples of which include high-speed random-access memory, such as DRAM, SRAM, DDR RAM, ROM, EEPROM, flash memory.

As is known in the art, a computer 900 can have different and/or other components than those shown in FIG. 9. In addition, the computer 900 can lack certain illustrated components. In one embodiment, a computer 900 acting as a server may lack a keyboard 910, pointing device 914, graphics adapter 912, and/or display 918. Moreover, the storage device 908 can be local and/or remote from the computer 900 (such as embodied within a storage area network (SAN)).

As is known in the art, the computer 900 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 908, loaded into the memory 906, and executed by the processor 902.

### Additional Considerations

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a computer system and a computerized process. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed. The scope of protection should be limited only by the following claims.

1. A method for relocalization of a target image with a relocalizer model comprising:
receiving a target image depicting a portion of a real-world environment;
determining a camera pose of the target image by applying the relocalizer model to the target image, wherein the relocalizer model was trained by:
obtaining image data comprising a plurality of training images captured by one or more cameras depicting the real-world environment;
identifying an initial training image from the image data for initializing the relocalizer model;
training the relocalizer model with the initial training image and an identity pose establishing a pose of the initial training image as reference;
performing an incremental training process comprising, in each of one or more iterations:
applying the relocalizer model to a subsequent set of training images from the image data to output a pose estimate for each training image in the subsequent set, and
retraining the relocalizer model using the subsequent set of training images and the pose estimates;
measuring performance of the relocalizer model with a validation set of training images from the image data; and
responsive to determining that an end condition is met based on the performance of the relocalizer model, ending the incremental training process; and
providing artificial reality content using the target image and based on the camera pose output by the relocalizer model.

2. The method of claim 1, wherein identifying the initial training image from the image data comprises randomly selecting the initial training image from the image data.

3. The method of claim 1, wherein training the relocalizer model with the initial training image comprises:
applying a reconstruction network to features of the initial training image to output a plurality of sets of scene coordinates representing spatial locations of pixels associated with one or more real-world objects in the real-world environment;
projecting the plurality of sets of scene coordinates into a two-dimensional projection based on the identity pose of the initial training image;
determining a loss between the two-dimensional projection and the initial training image; and
adjusting parameters of the reconstruction network to minimize the loss.

4. The method of claim 3, wherein training the relocalizer model comprises:
applying a feature network to the initial training image data to output the features of the initial training image.

5. The method of claim 4, wherein the feature network, the reconstruction network, or both are neural network models.

6. The method of claim 3, wherein determining the loss comprises computing a pixel-wise projection error between corresponding pixels of the two-dimensional projection and pixels of the initial training image.

7. The method of claim 1, wherein applying the relocalizer model to the subsequent set of training images data to output the pose estimate for each training image during the incremental training process comprises, for each training image:
applying a reconstruction network to features of the training image to output a plurality of sets of scene coordinates representing spatial locations of pixels associated with one or more real-world objects in the real-world environment;
determining a pose estimate for the training image based on the plurality of sets of scene coordinates output by the reconstruction network.

8. The method of claim 7, wherein determining the pose estimate for the training image comprises applying a perspective-n-point algorithm to the plurality of sets of scene coordinates to determine the pose estimate.

9. The method of claim 7, wherein retraining the relocalizer model using the subsequent set of training images and the pose estimates during the incremental training process comprises, for each training image:
applying a pose refinement network to modify the pose estimate of the training image to yield a refined pose estimate;
projecting the plurality of sets of scene coordinates into a two-dimensional projection for the training image based on the refined pose estimate of the training image;
determining a loss between the two-dimensional projection and the corresponding training image; and
adjusting parameters of the reconstruction network and the pose refinement network to minimize the loss.

10. The method of claim 7, wherein retraining the relocalizer model using the subsequent set of training images and the pose estimates during the incremental training process further comprises, for each training image:
applying dropout of one or more features, wherein the reconstruction network is applied to remaining features of the training image.

11. The method of claim 7, applying the relocalizer model to the subsequent set of training images data to output the pose estimate for each training image during the incremental training process further comprises, for each training image:
determining a confidence associated with the determined pose estimate based on the plurality of sets of scene coordinates;
responsive to determining the confidence is below a confidence threshold, removing the training image from the subsequent set prior to retraining the relocalizer model.

12. The method of claim 1, wherein providing the artificial reality content using the target image and based on the camera pose comprises:
generating augmented reality content by augmenting the target image with one or more virtual elements based on the camera pose output by the relocalizer model; and
providing the augmented reality content.

13. The method of claim 1, wherein providing the artificial reality content using the target image and based on the camera pose comprises:
generating a scene reconstruction based in part on the target image and the camera pose output by the relocalizer model; and
providing the scene reconstruction.

14. A method for training a relocalizer model, comprising:
obtaining image data comprising a plurality of training images captured by a camera of a real-world environment;
identifying an initial training image from the image data for initializing the relocalizer model;
training the relocalizer model with the initial training image and an identity pose establishing a pose of the initial training image as reference;
performing an incremental training process comprising:
applying the relocalizer model to a subsequent set of training images from the image data to output a pose estimate for each training image in the subsequent set, and
retraining the relocalizer model using the subsequent set of training images and the pose estimates;
measuring performance of the relocalizer model with a validation set of training images from the image data; and
responsive to determining that an end condition is met based on the performance of the relocalizer model, ending the incremental training process.

15. The method of claim 14, wherein training the relocalizer model with the initial training image comprises:
applying a reconstruction network to features of the initial training image to output a plurality of sets of scene coordinates representing spatial locations of pixels associated with one or more real-world objects in the real-world environment;
projecting the plurality of sets of scene coordinates into a two-dimensional projection based on the identity pose of the initial training image;
determining a loss between the two-dimensional projection and the initial training image; and
adjusting parameters of the reconstruction network to minimize the loss.

16. The method of claim 15, wherein training the relocalizer model comprises:
applying a feature network to the initial training image data to output the features of the initial training image.

17. The method of claim 14, wherein applying the relocalizer model to the subsequent set of training images data to output the pose estimate for each training image during the incremental training process comprises, for each training image:
applying a reconstruction network to features of the training image to output a plurality of sets of scene coordinates representing spatial locations of pixels associated with one or more real-world objects in the real-world environment;
determining a pose estimate for the training image based on the plurality of sets of scene coordinates output by the reconstruction network.

18. The method of claim 17, wherein determining the pose estimate for the training image comprises applying a perspective-n-point algorithm to the plurality of sets of scene coordinates to determine the pose estimate.

19. The method of claim 17, wherein retraining the relocalizer model using the subsequent set of training images and the pose estimates during the incremental training process comprises, for each training image:
applying a pose refinement network to modify the pose estimate of the training image to yield a refined pose estimate;
projecting the plurality of sets of scene coordinates into a two-dimensional projection for the training image based on the refined pose estimate of the training image;
determining a loss between the two-dimensional projection and the corresponding training image; and
adjusting parameters of the reconstruction network and the pose refinement network to minimize the loss.

20. The method of claim 17, applying the relocalizer model to the subsequent set of training images data to output the pose estimate for each training image during the incremental training process further comprises, for each training image:
determining a confidence associated with the determined pose estimate based on the plurality of sets of scene coordinates;
responsive to determining the confidence is below a confidence threshold, removing the training image from the subsequent set prior to retraining the relocalizer model.
